(19) United States
(12) Patent Application Publication
(10) Pub. No.: US 2009/0046313 A1
(43) Pub. Date: Feb. 19, 2009

(54) Image Processing Apparatus and Image Processing Method

(75) Inventor: Katsushi MINAMINO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/184,017

(22) Filed: Jul. 31, 2008

(30) Foreign Application Priority Data
Aug. 17, 2007 (JP) 2007-213054

(51) Int. Cl. G06F 3/12; H04N 1/46

(52) U.S. Cl. 358/1.13; 358/505

(57) ABSTRACT

An image processing apparatus acquires an image by optically scanning an original document and determines whether or not the document is of standard size. A histogram is created indicating the number of pixels with respect to each luminance value of the acquired image. A background color peak is specified that corresponds to a background color of the original document in the created histogram. A background color portion of the original document is specified that corresponds to a luminance area including the background color peak. The background color portion is replaced with a white color that will not be a target for printing.

### CROSS-REFERENCE TO RELATED APPLICATIONS

This application claims priority under 35 U.S.C. 119 to Japanese Patent Application No. 2007-213054, filed on Aug. 17, 2007, which application is hereby incorporated by reference in its entirety.

### BACKGROUND OF THE INVENTION

1. Field of the Invention

The present invention relates to an image processing apparatus and method that detect a background color of an original document and perform a process of successfully removing the background color.

2. Description of the Related Art

Conventionally, when an original document is scanned by a scanner device, a copier, a facsimile machine or a Multi Function Peripheral (MFP), a background color of the original document is detected, and a process of removing the background color is performed.

For example, in scanning by a Flat Bed Scanner (FBS), a light source is actuated immediately before an original document cover is closed, and a width or an edge of the original document placed on an original document table glass is detected. The detected width or edge of the original document is compared with information of an original document of standard size that is prestored in the apparatus. Thus, a size of the placed original document is determined. Then, a portion corresponding to a leading edge portion of the original document whose size was determined is scanned. Based on image data acquired by the scanning, the background color of the original document is detected.

However, according to the above-described conventional art, when an original document placed on the original document table glass is of non-standard size such as a newspaper clipping, or even when an original document is of standard size, if such document is not placed along a guide, a problem arises in that its background color cannot be detected accurately. This is because, in the conventional art, detecting the background color first requires detection of the leading edge portion of the original document, which cannot be detected when the original document is of non-standard size or is not placed along the guide.

### SUMMARY OF THE INVENTION

The present invention overcomes these problems, and provides an image processing apparatus that can detect and successfully remove a background color even when an original document is of non-standard size or is not placed along a guide.

According to an aspect of the present invention, an image processing apparatus performs image processing on an image acquired by optically scanning an original document. The image processing apparatus includes an image acquiring unit that acquires the image by optically scanning the original document; an, original-document determining unit that determines whether or not the original document is of standard size; a background-color-portion specifying unit that creates, when the original-document determining unit determines that the original document is not of standard size, a histogram indicating the number of pixels with respect to each luminance value of the image acquired by the image acquiring unit, specifies a background color peak that corresponds to a background color of the original document in the created histogram, and specifies, as a background color portion, a portion of the original document that corresponds to a luminance area including the background color peak; and a background-color replacing unit that replaces the background color portion with a color that will not be a target for printing.

Accordingly, even when the original document is not of standard size or is not placed along the guide, the background color portion of the original document can be detected, and the background color can be successfully removed.

When the original-document determining unit determines that the original document is not of standard size, the original-document-portion specifying unit may specify, as the background color portion, a portion at which a color predetermined as a background color of a newspaper is represented in the image.

Thus, the background color of the newspaper, which has a more conspicuous background color compared with that of other original documents, can be successfully removed.

According to another aspect of the present invention, an image processing apparatus performs image processing on an image acquired by optically scanning an original document. The image processing apparatus includes an image acquiring unit that acquires the image by optically scanning the original document; a background-color-portion specifying unit that creates, when an instruction indicating that the original document is a newspaper clipping is acquired from an operator, a histogram indicating the number of pixels with respect to each luminance value of the image acquired by the image acquiring unit, specifies a background color peak that corresponds to a background color of the original document in the created histogram, and specifies, as a background color portion, a portion of the original document that corresponds to a luminance area including the background color peak; and a background-color replacing unit that replaces the background color portion with a color that will not be a target for printing.

Thus, the background color can be removed by the instruction from the operator, and the image processing of the present invention can be prevented from being performed when it is not necessary to remove the background color.

When the instruction indicating that the original document is a newspaper clipping is acquired from the operator, the background-color-portion specifying unit may specify, as the background color portion, a portion at which a color predetermined as a background color of a newspaper is represented in the image.

Thus, the background color of the newspaper, which has a more conspicuous background color compared with that of other original documents, can be successfully removed.

The image processing apparatus further includes an original-document cover unit that is able to cover and press the original document to be scanned by the image acquiring unit and that has a surface with a luminance higher than that of the background color of a newspaper. Moreover, when the original-document cover unit is opened when the original document is scanned, the background-color-portion specifying unit may specify, in the histogram., a platen peak as a peak that corresponds to a luminance value of the surface of the original-document cover unit, and the background color peak as a peak that is closer to black than the platen peak. Further, when the original-document cover unit is closed when the original document is scanned, the background-color-portion specifying unit may specify, in the histogram, the background color peak as a first local maximum portion on a side of higher luminance, and an open peak as a first local maximum portion on a side of lower luminance.

Thus, the peak that corresponds to the background color can be reliably determined from the histogram indicating the number of pixels with respect to each luminance, and the background color can be successfully removed.

According to the present invention, even when an original document is of non-standard size or is not placed along a guide, an image processing apparatus can detect and successfully remove a background color of the original document.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a perspective view of an MFP as an example of an image processing apparatus according to the present invention.

FIG. 2 is an enlarged perspective view of a scanner unit of the image processing apparatus.

FIG. 3 is a block diagram of a hardware configuration of the image processing apparatus.

FIG. 4 is a block diagram illustrating a characteristic function configuration of the image processing apparatus.

FIG. 5 is a flowchart illustrating a procedure of an image processing method by the image processing apparatus performed when an original document cover is closed.

FIG. 6 is a histogram illustrating the relation of luminance and the number of pixels of an image scanned when the original document cover is closed.

FIG. 7 is a table illustrating the relation of the number of pixels and a threshold value of the image.

FIG. 8 is a graph illustrating the relation of a luminance value input from a background-color replacing unit and a luminance value after correction.

FIG. 9 is a histogram illustrating the relation of luminance and the number of pixels of an image scanned when the original document cover is opened.

FIG. 10 is a flowchart illustrating a procedure of an image processing method by the image processing apparatus performed when the original document cover is opened.

FIG. 11 is a graph illustrating the relation of a luminance value input from the background-color replacing unit and a luminance value after correction.

FIG. 12 illustrates the setting of a newspaper-clipping mode performed by an operator.

FIG. 13 is a flowchart illustrating a procedure of an image processing method by the image processing apparatus.

### DETAILED DESCRIPTION OF EMBODIMENTS OF THE INVENTION

With reference to the drawings, embodiments of the present invention are now described in detail. Hereinafter, an MFP including an image processing apparatus is described as an example of the present invention.

### First Embodiment

When scanning a placed original document in a state in which an original document cover for preventing the effect of ambient light is closed, the image processing apparatus of the first embodiment of the invention detects and successfully removes a background color of the original document.

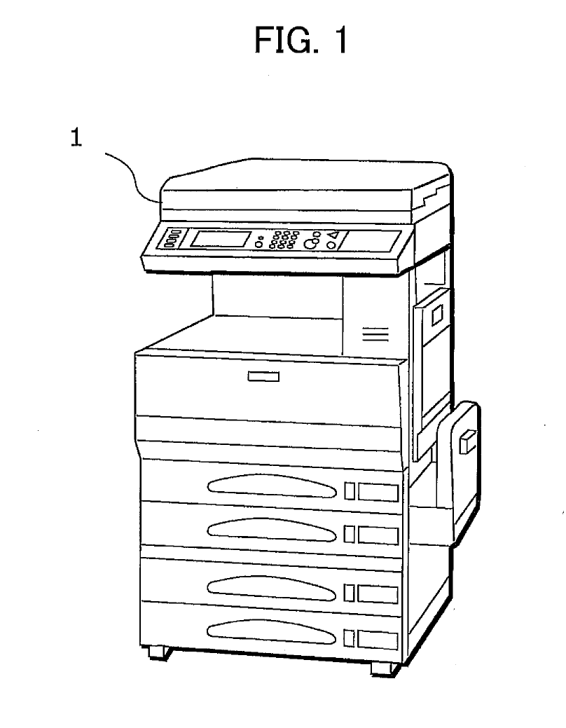

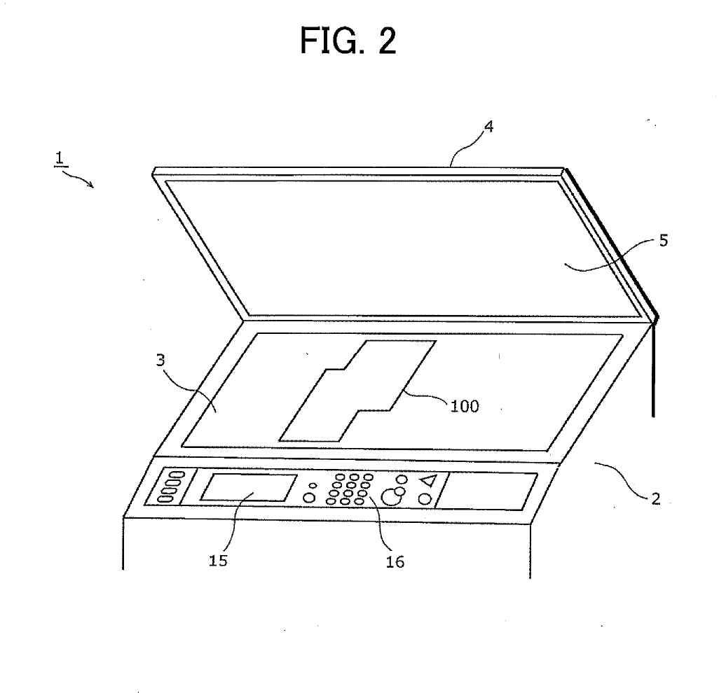

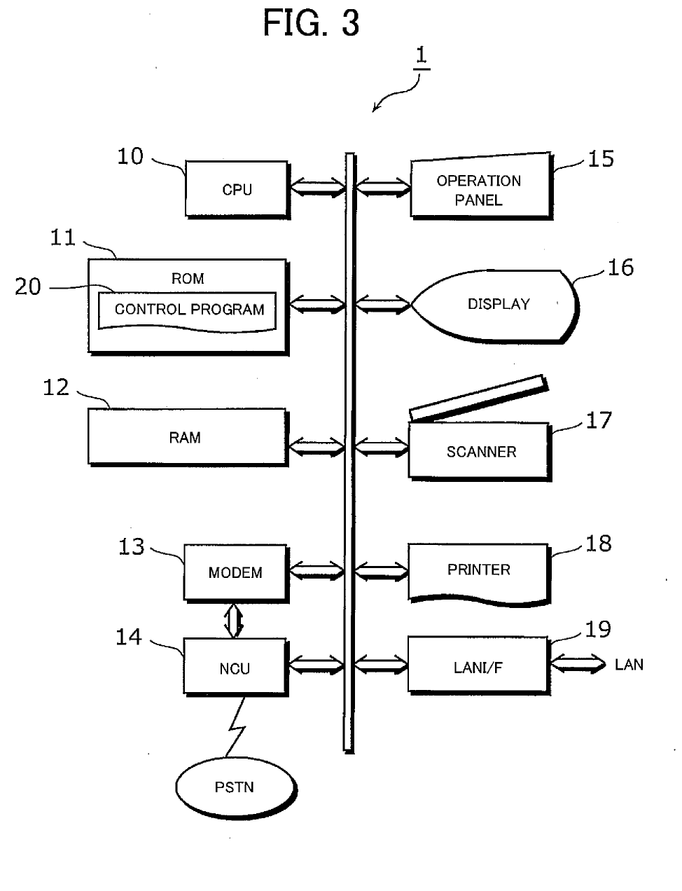

FIG. 1 is a perspective view of an MFP 1 including the image processing apparatus of the present embodiment. FIG. 2 is an enlarged perspective view of an original-document scanning unit of the MFP 1 illustrated in FIG. 1. An original document table 2, an original document table glass 3, an original document cover 4, a platen sheet 5, an operation panel 15, a display 16, and a newspaper clipping 100 as an example of an original document, are illustrated in FIG. 2. FIG. 3 is a block diagram of a hardware configuration of the MFP 1. As illustrated in FIG. 3, the MFP 1 includes a Central Processing Unit (CPU) 10, a Read only Memory (ROM) 11, a Random Access Memory (RAM) 12, a modem 13, a Network Control Unit (NCU) 14, the operation panel 15, the display 16, a scanner 17, a printer 18, and a Local Area Network InterFace (LAN I/F) 19.

The CPU 10 is a processor that executes a control program 20 stored in the ROM 11.

The ROM 11 is a read only memory that stores the control program 20 etc. The RAM 12 is a work area used when the CPU 10 executes the control program 20, and is a readable/writable memory including a volatile storage area etc. that temporarily stores image data or the like scanned by the scanner 17.

The modem 13 is a facsimile modem that modulates image data to be transmitted via facsimile or demodulates image data transmitted via facsimile from outside.

The NCU 14 is circuit terminating equipment that is connected to Public Switched Telephone Networks (PSTN).

The operation panel 15 receives operations from an operator such as, for example, an instruction for starting scanning of an original document or setting of a newspaper-clipping mode, to be described later.

The display 16 is a Liquid Crystal Display (LCD) or the like. The display 16 is used for dialogue with the operator or displays an operational state of the MFP 1.

The scanner 17 is an image scanning device that scans, by a Charge Coupled Device (CCD) etc., the content of an original document to be transmitted via facsimile or to be copied and output by the printer 18, and that generates image data.

The printer 18 is a printing device and prints, for example, images etc. scanned by the scanner 17. The printer 18 also prints image data transmitted from a destination facsimile machine or the like via the PSTN, NCU 14, and modem 13.

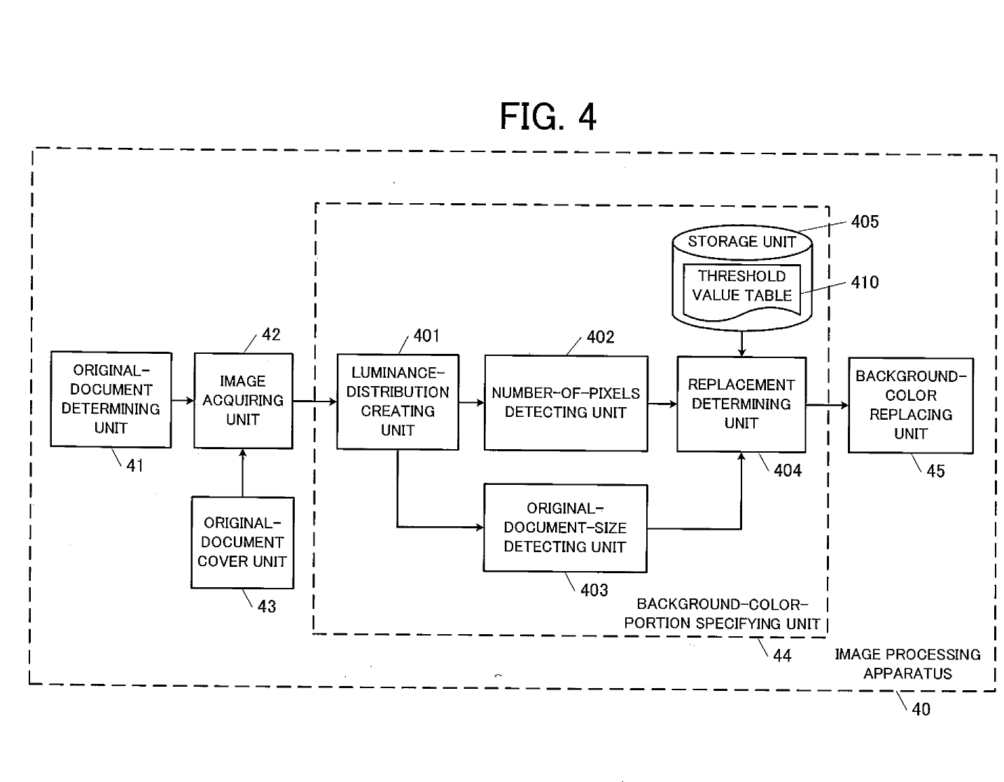

The LAN I/F 19 is a communication adapter that connects the MFP 1 with the LAN. FIG. 4 is a block diagram illustrating a characteristic function configuration of the image processing apparatus of the present invention. That is, FIG. 4 is a block diagram illustrating functions of the present invention that are included in functions of the image processing apparatus achieved by the hardware configuration illustrated in FIG. 3.

An image processing apparatus 40 functionally includes an original-document determining unit 41, an image acquiring unit 42, an original document cover 43, a background-color-portion specifying unit 44, and a background-color replacing unit 45.

The original-document determining unit 41 is a processing unit that determines whether or not an original document is of standard size, and corresponds to the scanner 17, the CPU 10, the ROM 11, and the RAM 12 in FIG. 3. It is assumed that the original document has been placed along a guide, and by detecting an edge portion of the original document, the original-document determining unit 41 determines whether or not the detected edge portion matches an edge portion of an original document of prestored standard size. In a case where the edge portion of the original document cannot be detected, and in a case where the detected edge portion of the original document does not match the edge portion of a standard size original document, the original-document determining unit 41 determines that the original document is of non-standard size. In other cases, such as when it is determined that an original document is of standard size, it is further determined which standard size the original document matches, from a combination of a width of the original document and a length detected by using at least one length detecting sensor.

The image acquiring unit 42 is a processing unit that acquires an image by optically scanning the original document, and corresponds to the scanner 17 in FIG. 3.

The original-document cover unit 43 corresponds to the scanner 17 in FIG. 3, and to the original document cover 4 and the platen sheet 5 in FIG. 2. The original document cover 4 can be opened and closed, and when closed, the cover 4 can prevent the effect of disturbance light. By covering a portion where the original document is not placed, when the image acquiring unit 42 scans the original document, the platen sheet 5 prevents the portion where the original document is not placed from being scanned in black. This is because the platen sheet 5 includes, for example, a white or yellow surface, which has a higher luminance than that of the background color of an original document such as a newspaper.

The background-color-portion specifying unit 44 is a processing unit that specifies a background color portion at which the background color of the original document is represented in the image acquired by the image acquiring unit 42. The background-color-portion specifying unit 44 corresponds to the CPU 10, the ROM 11, and the RAM 12 in FIG. 3. The background-color-portion specifying unit 44 includes a luminance-distribution creating unit 401, a number-of-pixels detecting unit 402, an original-document-size detecting unit 403, a replacement determining unit 404, and a storage unit 405.

The luminance-distribution creating unit 401 creates a histogram that indicates the number of pixels with respect to each luminance, from the image data acquired by the image acquiring unit 42. Based on a luminance value of each pixel, a histogram indicating the luminance on the horizontal axis and the number of pixels on the vertical axis is created. The luminance is represented by numeric values of 0-255, wherein the color turns black as the luminance comes closer to 0, and turns white as the luminance comes closer to 255.

The number-of-pixels detecting unit 402 counts the number of pixels of the histogram created by the luminance-distribution creating unit 401. In the present embodiment, the luminance values are sectionalized by 16 such that the luminance values of 0-15 are a first section, the luminance values of 16-31 are a second section, . . . and the luminance values of 240-255 are a sixteenth section. By counting the number of pixels included with respect to each section, it is detected which section has a large number of pixels.

By calculating the area, that is, the number of pixels from the histogram created by the luminance-distribution creating unit 401, the original-document-size detecting unit 403 detects the size of the placed original document. For example, the area of the original document can be determined in accordance with the total number of pixels in the first section through the fifteenth section.

Alternatively, the area of the original document can be determined by using the following method. When the placed original document is a newspaper clipping, for example, a character peak indicating characters described in the original document normally appears substantially at a position of luminance value of 70. A background color peak indicating the background color of the newspaper clipping appears substantially at a position of luminance value of 210. The total number of pixels of the sections from the character peak to the background color peak indicates the size of the placed original document. Accordingly, the original-document-size detecting unit 403 first calculates the total number of pixels included in a range from the fifth section (luminance values of 64-79), which includes the luminance value of 70, to the fourteenth section (luminance values of 208-223), which includes the luminance value of 210. Generally, as the calculated total number of pixels increases, the size of the placed original document becomes larger. Based on the calculated total number of pixels, a threshold value used by the replacement determining unit 404 (described below) is determined.

The replacement determining unit 404 determines whether or not to replace the portion to be the background color with a white color. Here, white is a color that will not be a target for printing. In other words, the printing device does not record the portion replaced with the white color in any color materials. The replacement determining unit 404 first specifies the luminance indicating the background color of the original document, from the number of pixels acquired by the number-of-pixels detecting unit 402. Then, the replacement determining unit 404 reads out from a threshold value table 410, the threshold value that corresponds to the size of the original document detected by the original-document-size detecting unit 403, and determines to replace the background color with the white color when the specified luminance meets a requirement of threshold value.

The storage unit 405 stores the threshold value table 410 indicating the threshold value that corresponds to the size of the original document, that is, the total number of pixels.

The background-color replacing unit 45 is a processing unit that replaces the background color portion specified by the background-color-portion specifying unit 44 with the white color. The background-color replacing unit 45 corresponds to the CPU 10, the ROM 11, and the RAM 12 in FIG. 3. When the replacement determining unit 404 determines to replace the background color with the white color, the background-color replacing unit 45 replaces all pixels having a luminance exceeding the luminance value that corresponds to the background color, with the white color.

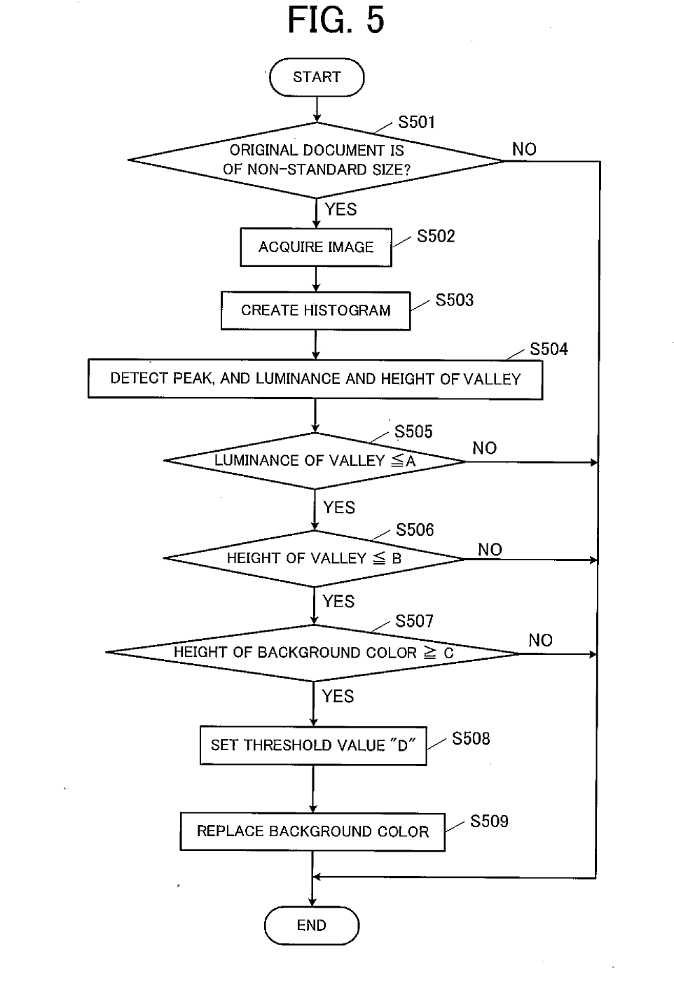

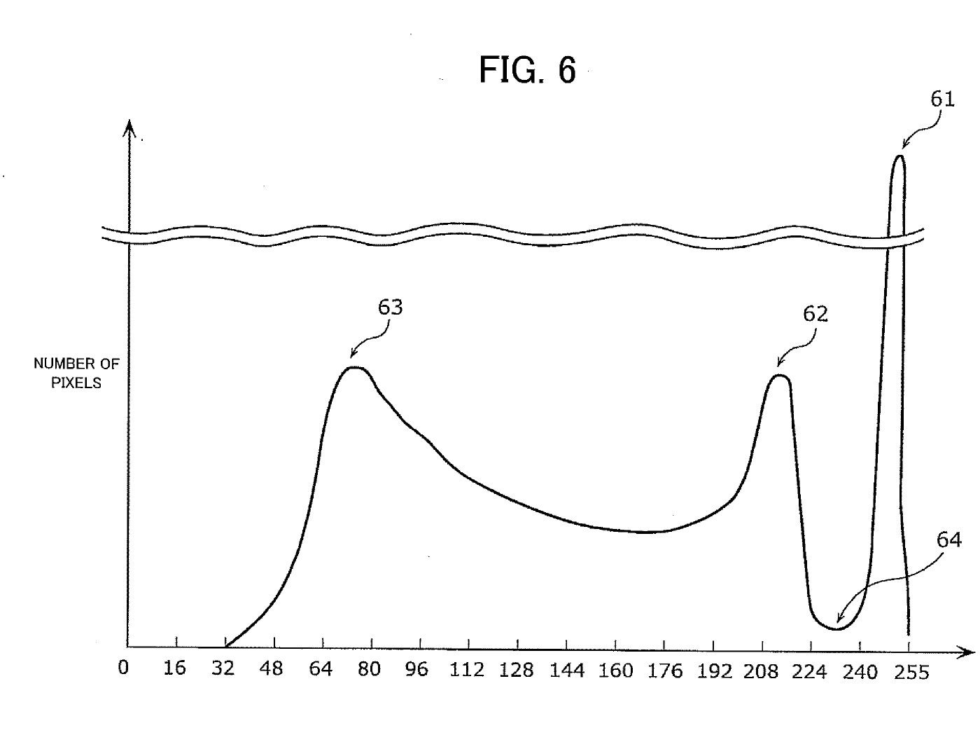

Next, an image processing method of the first embodiment of the invention is described with reference to the flowchart of FIG. 5. An original document is placed on the original document table glass 3. Immediately before the original document cover 4 is closed, the original-document determining unit 41 determines whether or not the original document is of standard size (S501). When the original document is of standard size (“NO” in S501), image processing of this embodiment is ended. When the original document is not of standard size (“YES” in S501), the image acquiring unit 42 scans the placed original document and acquires image data (S502). Based on the luminance value of each pixel included in the acquired image data, the luminance-distribution creating unit 401 creates a histogram indicating the luminance on the horizontal axis and the number of pixels on the vertical axis (S503). An example of a histogram created when a newspaper clipping is scanned is illustrated in FIG. 6. By counting the number of pixels of the created histogram, the number-of-pixels detecting unit 402 detects a section with a local maximum number of pixels and a section with a local minimum number of pixels. Counting from a side of higher luminance, a first local maximum portion is set as a platen sheet peak 61 and a second local maximum portion is set as a background color peak 62 (S504). Counting from a side of lower luminance, a first maximum portion is set as a character peak 63. The platen sheet peak 61 indicates the luminance of the platen sheet, the background color peak 62 indicates the background color of the newspaper. A clear valley 64 appears between the platen sheet peak 61 and the background color peak 62. Normally, the platen sheet peak 61 is the sixteenth section (luminance values of 240-255), the valley 64 is the fifteenth section (luminance values of 224-239), and the background color peak 62 is the thirteenth section (luminance values of 192-207) or the fourteenth section (luminance values of 208-223). The valley 64 indicates a boundary between the original document and the platen sheet. Accordingly, when the valley 64 does not clearly appear, and when the background color peak 62 does not clearly appear, such as when the scanned original document is not a newspaper, it is not necessary to replace the background color. That is because the background color is sufficiently white or the background color portion is extremely small.

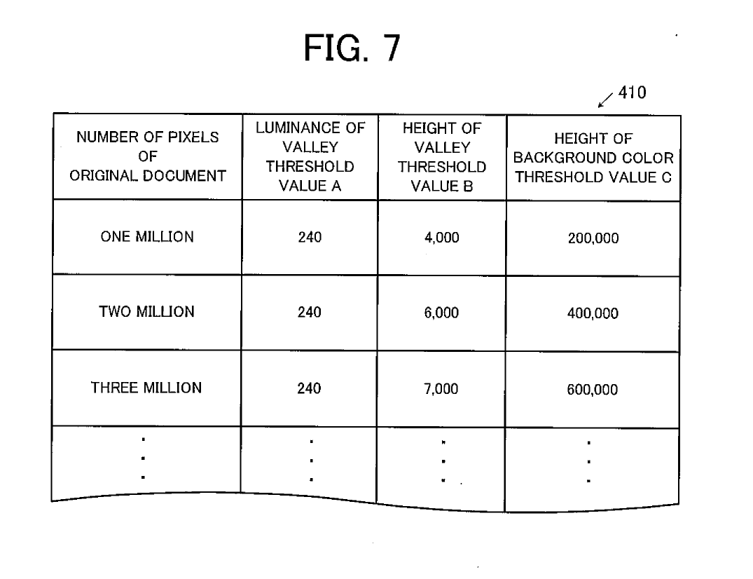

The replacement determining unit 404 then determines whether or not to replace the background color portion included in the image data acquired by the image acquiring unit 42 with the white color. First, it is determined whether or not the luminance indicating a position of the valley 64 is less than or equal to a threshold value “A” (S505). The threshold value “A” is determined based on the brightness of the platen sheet. More specifically, the threshold value “A” is determined based on a minimum value of the values acquired when the platen sheet is scanned. For example, as illustrated in FIG. 7, the threshold value “A” is 240. Then, it is determined whether or not the number of pixels that indicates the height of the valley 64 and is included in the section indicating the valley 64 is less than or equal to a threshold value “B” (S506). The threshold value “B”, which is used for determining the number of pixels of the valley 64, can be determined in accordance with the area or outer circumference of the original document. For example, as illustrated in FIG. 7, when the total number of pixels of the original document is one million pixels, the threshold value “B” is 4000. Then, it is determined whether or not the number of pixels that indicates the height of the background color peak 62 and is included in the section indicating the background color peak 62 is more than or equal to a threshold value “C”. The threshold value “C” is determined in accordance with the size of the original document, and for example, as illustrated in FIG. 7, when the total number of pixels of the original document is one million pixels, the threshold value “C” is 200000. In accordance with the above three determinations, when it is determined that the background color should be replaced with the white color (“YES” in S507), the replacement determining unit 404 sets the threshold value “D” such that the luminance value of the background color peak 62 is always included in the luminance that is more than or equal to the threshold value “D” (S508). For example, as illustrated in FIG. 6, when the background color peak 62 is in the fourteenth section, the threshold value “D” is set to be 208, which is the beginning threshold value of the fourteenth section.

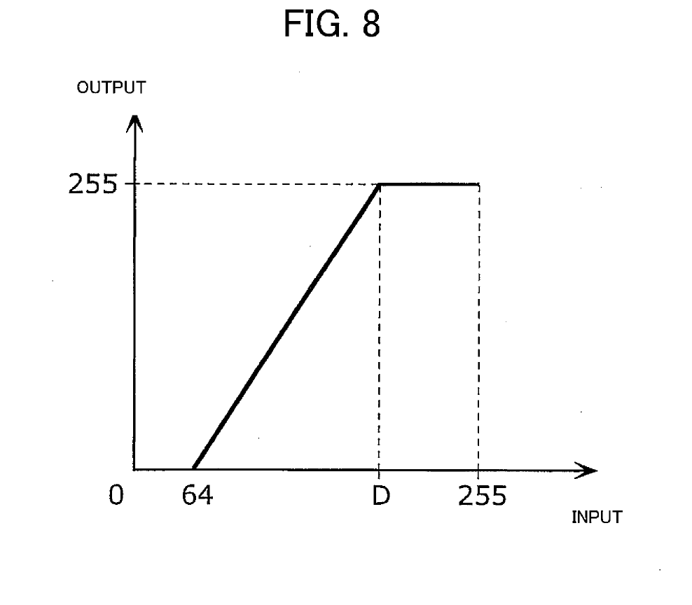

The background-color replacing unit 45 then replaces all luminance values that are more than or equal to the threshold value “D” and that are included in the image data with the luminance value (for example, 255) that indicates the white color, which is not the target for printing (S509). FIG. 8 illustrates the relation of the input luminance value and the luminance value after correction. By performing the correction of FIG. 8 on the luminance values that are less than or equal to the threshold value “D”, the background color can be turned white, and black characters can be turned blacker. Thus, the image after the background color replacement, that is, the image output after the correction, has enhanced contrast.

The background color of a newspaper is defined, for example, in the “Japan Color for Newspapers” by Japan Printing Machinery Manufactures Association. By comparing the threshold value “D” with the defined background color, it can be confirmed whether or not the set threshold value “D” is proper as the background color of the newspaper.

Thus, according to the image processing apparatus in the present embodiment, even when the original document is of non-standard size or is not placed along the guide, the background color of the original document can be detected and successfully removed.

### Second Embodiment

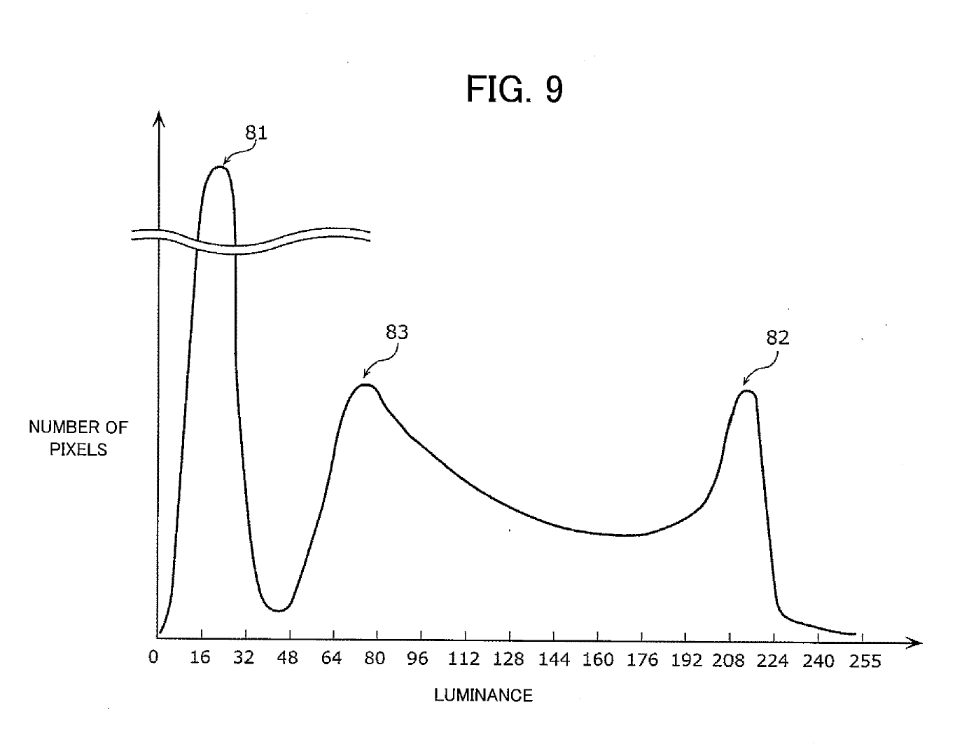

When scanning a placed original document in a state in which the original document cover for preventing the effect of disturbance light is opened, the image processing apparatus in the second embodiment detects and successfully removes the background color of the original document. Compared with the first embodiment, a difference in the second embodiment is that the original document is scanned while the original document cover is opened. Thus, as illustrated in FIG. 9, when scanned image data is expressed in the histogram, the histogram does not have the platen sheet peak 61 that appears in FIG. 6. Instead, an open peak 81 appears in the vicinity of luminance value of 0. The open peak 81 indicates that a surrounding area of the original document turns black by the effect of disturbance light occurred due to having the original document scanned while the original document cover 4 is opened. A sensor (not illustrated) provided to the original document cover 4 detects whether the original document cover 4 is opened or closed.

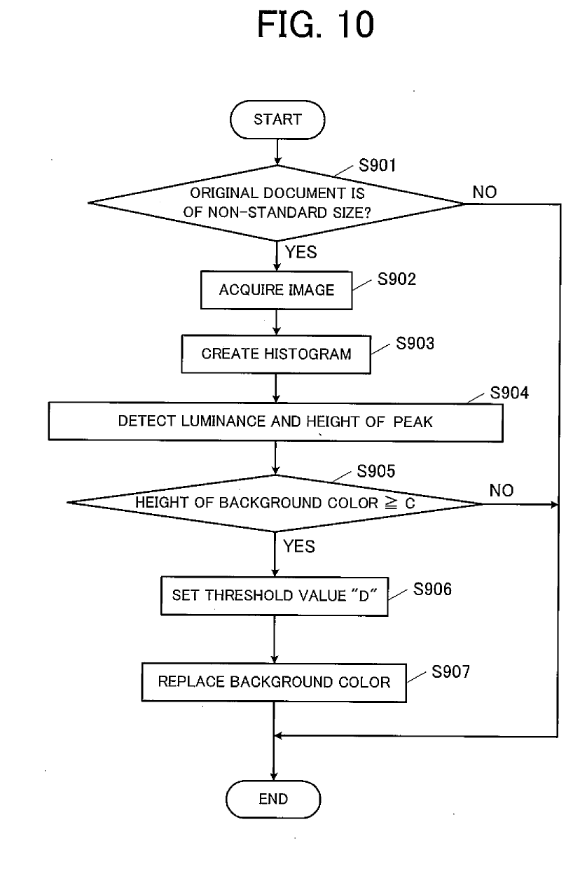

FIG. 10 is a flowchart of an image processing method using the image processing apparatus of the second embodiment. Compared with the flowchart of the image processing method of the first embodiment in FIG. 5, a different determining method regarding the replacement of the background color is used in the present embodiment. Hereinafter, the description of respects similar to those of FIG. 5 will be omitted, and different respects are mainly described.

When the original document is placed on the original document table glass 3, the original-document determining unit 41 determines whether or not the original document is of standard size (S901). When the original document is of standard size (“NO” in S901), the image processing of the second embodiment is ended. When the original document is not of standard size (“YES” in S901), the image acquiring unit 42 scans the placed original document and acquires image data (S902). Based on the luminance value of each pixel, the luminance-distribution creating unit 401 creates a histogram indicating the luminance on the horizontal axis and the number of pixels on the vertical axis (S903). An example of the created histogram is illustrated in FIG. 9. The histogram of FIG. 9 is an example of a histogram created when a newspaper clipping is scanned while the original document cover 4 is opened. By counting the number of pixels of the created histogram, the number-of-pixels detecting unit 402 detects the section with a local maximum number of pixels and the section with a local minimum number of pixels. Counting from a side with higher luminance, a first local maximum portion is set as a background color peak 82. Counting from a side with lower luminance, a first local maximum portion is set as an open peak 81, and a second local maximum portion is set as a character peak 83 (S904). Normally, the open peak 81 is the first section (luminance values of 0-15) or the second section (luminance values of 16-31). In the case of a newspaper clipping, the character peak 83 is in the fifth section (luminance values of 64-80), and the background color peak 82 is in the thirteenth section (luminance values of 192-207) or in the fourteenth section (luminance values of 208-223).

The replacement determining unit 404 determines whether or not to replace the background color with the white color. It is determined whether or not the number of pixels that indicates the height of the background color peak 82 and that is included in the section indicating the background color peak 82 is more than or equal to the threshold value “C” (S905). Similar to the first embodiment, the threshold value “C” is determined in accordance with the size of the original document, and for example, as illustrated in FIG. 7, when the total number of pixels of the original document is one million pixels, the threshold value “C” is 200000. When it is determined that the background color should be replaced with the white color (“YES” in S905), the replacement determining unit 404 sets the threshold value “D” such that the luminance value of the background color peak is always included in the luminance that is more than or equal to the threshold value “D” (S906). A method for setting the threshold value “D” is similar to that of the first embodiment.

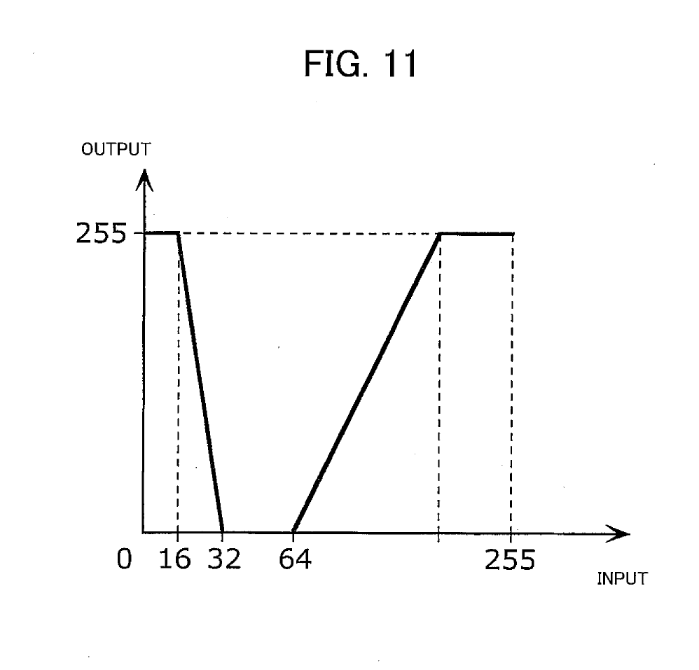

The background-color replacing unit 45 replaces all luminance values that are more than or equal to the threshold value “D” with the luminance value (for example, 255) that indicates the white color (S907). FIG. 11 illustrates the relation of the input luminance value and the luminance value after correction. In addition to the first embodiment, since it can be assumed that the luminance value of the first section is affected by the open peak 81, by replacing the input luminance value with the luminance value of 255 as illustrated in FIG. 11, the background color can be replaced with the white color. In addition to replacing the background color with the white color by the above-described correction, the black portion appeared around the original document can be replaced with the white color, and moreover, the black characters can be blacker.

Thus, according to the image processing apparatus in the second embodiment, even when an original document is of non-standard size or is not placed along the guide, and the original document cover is not closed, the background color of the original document can be detected and successfully removed.

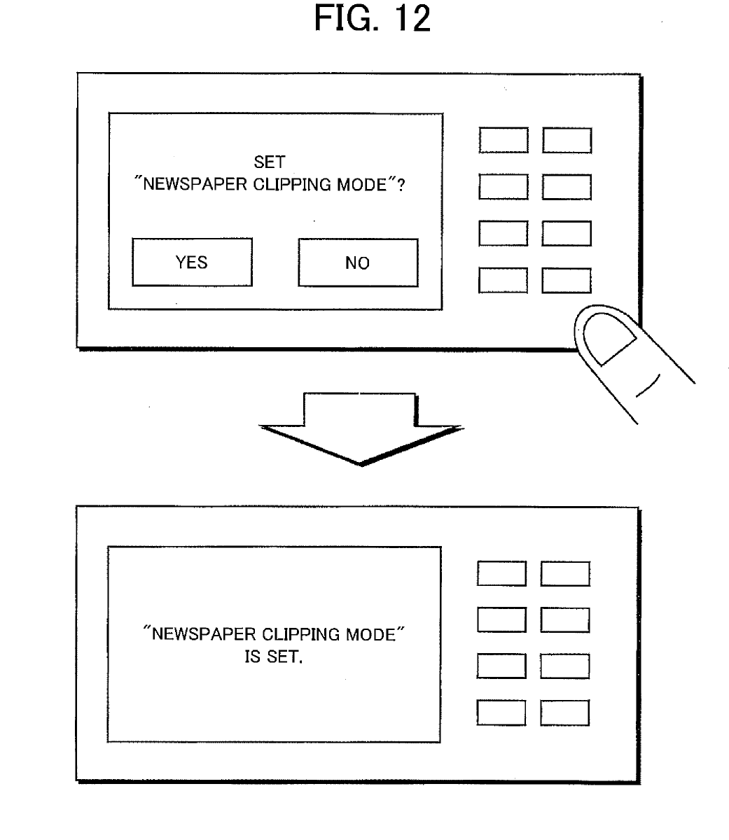

According to the embodiments of the present invention, when the original-document determining unit 41 determines that a scanned original document is of standard size, the process of specifying the background color and the process of replacing the background color are performed, however, those processes may be performed based on instructions from the operator. In other words, by operating the operation panel, the operator selects a “newspaper clipping mode” illustrated in FIG. 12. When the “newspaper clipping mode” is selected, the image processing of the present embodiments (S502-S509 of FIG. 5 or S902-S907 of FIG. 10) is executed.

Further, when the “newspaper clipping mode” is selected, the replacement determining unit 404 may use a predetermined threshold value “D”. In such a case, for example, the threshold value “D” that corresponds to the “newspaper clipping mode” is set according to the above-described “Japan Color for Newspapers” and stored in the storage unit 405.

In the present embodiments, the sensor provided to the original document cover 4 detects the opening and closing of the original document cover 4, however, the opening and closing of the original document cover 4 may be detected by scanning the original document regardless of the opening and closing of the original document cover 4, and creating the histogram. That is, as described above, when the original document cover 4 is closed, the platen sheet peak 61 appears in the vicinity of the sixteenth section, and when the original document cover 4 is opened, the open peak 81 appears in the vicinity of the first or second section. By determining the existence or absence of these peaks, the opening and closing of the original document cover 4 may be detected.

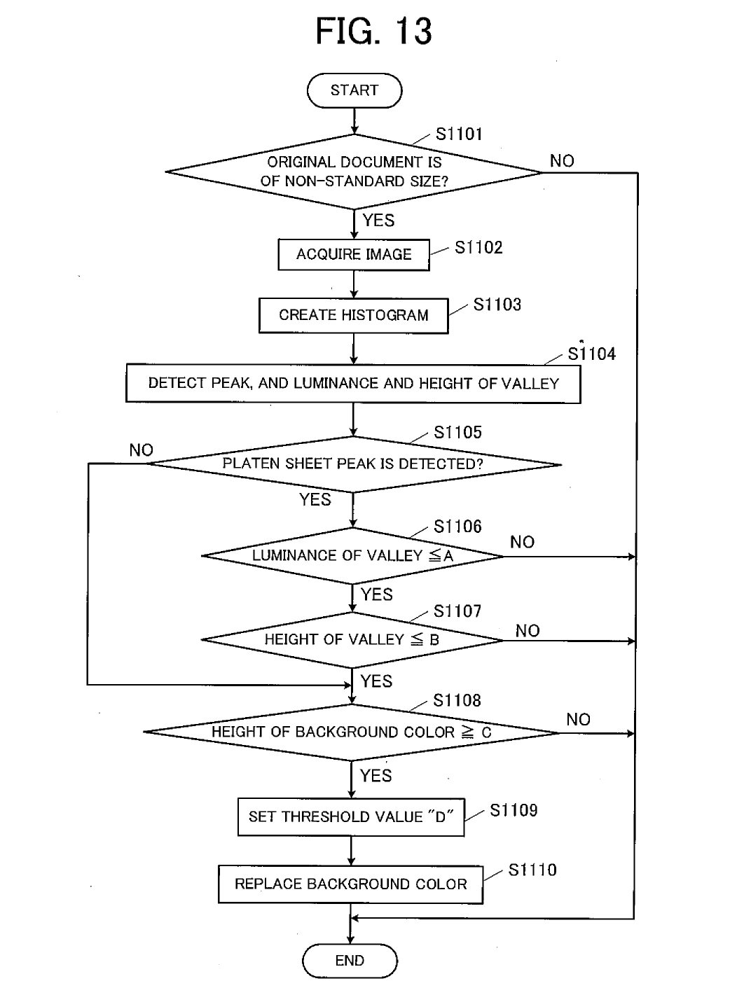

FIG. 13 illustrates a flowchart of a process procedure of the image processing apparatus of the above case. Compared with the process procedure of FIG. 5, a determination of the existence or absence of the platen sheet peak 61 is newly added (S1105). When the platen sheet peak 61 is detected (“YES” in S1105), a process of determining the luminance of the valley, the height of the valley, and the height of the background color is performed (S1106 through S1108). When the platen sheet peak 61 is not detected (“NO” in S1105), a process of determining the height of the background color is performed (S1108).

Furthermore, instead of determining the existence or absence of the platen sheet peak 61, the existence or absence of the open peak 81 may be determined. In such a case, when the open peak 81 is not detected, the process of determining the luminance of the valley, the height of the valley, and the height of the background color is performed (S1106 through S1108). When the open peak 81 is detected, the process of determining the height of the background color is performed (S1108).

In the present embodiments, the luminance values are sectionalized by 16, and by counting the number of pixels with respect to each section, the peaks and valley are detected. However, by counting the number of pixels with respect to each luminance value, the peaks and valley may be detected. Thus, more accurate detection of the background color can be achieved.

By the above-described configuration, regardless of the opening and closing of the original document cover, the image processing method of the present invention can be executed as a single software component.

The present invention can be achieved not only as an apparatus, but also as a method including, as steps, the processing units that constitutes the apparatus, or also as a program for causing a computer to execute the steps. The present invention can also be achieved as a computer-readable recording medium such as a CD-ROM in which such program is recorded, or as information, data, or signals that indicate the program. Such program, information, data, and signals may be distributed via a communication network such as the Internet.

For example, in an MFP, the present invention can be used as the image processing apparatus that can successfully remove a background color when scanning an original document of non-standard size such as a newspaper clipping.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications that fall within the true spirit and scope of the present invention.

What is claimed is:

1. An image processing apparatus comprising:
an image acquiring unit that acquires an image by optically scanning an original document;
an original-document determining unit that determines whether or not the original document is of standard size;
a background-color-portion specifying unit that creates, when the original-document determining unit determines that the original document is not of standard size, a histogram indicating the number of pixels with respect to each luminance value of the image acquired by the image acquiring unit, specifies a background color peak that corresponds to a background color of the original document in the created histogram, and specifies, as a background color portion, a portion of the original document that corresponds to a luminance area including the background color peak; and
a background-color replacing unit that replaces the background color portion with a color that will not be a target for printing.

2. The image processing apparatus according to claim 1, wherein when the original-document determining unit determines that the original document is not of standard size, the background-color-portion specifying unit specifies, as the background color portion, a portion at which a color predetermined as a background color of a newspaper is represented in the image.

3. The image processing apparatus according to claim 1, further comprising an original document cover unit that is able to cover and press the original document to be scanned by the image acquiring unit, and that has a surface having a high luminance.

4. The image processing apparatus according to claim 3, wherein, when the original document cover unit is closed when the original document is scanned:
the background-color-portion specifying unit specifies, in the histogram, a platen peak as a peak that corresponds to a luminance value of the surface of the original-document cover unit, and the background color peak as a peak that is closer to black than the platen peak.

5. The image processing apparatus according to claim 4, wherein
in the histogram, a valley is present between the background color peak and the platen peak;
when the background-color-portion specifying unit determines that:
a luminance value indicating a position of the valley is less than or equal to a threshold value A;
the number of pixels that indicates a height of the valley is less than or equal to a threshold value B; and
the number of pixels that indicates a height of the background color peak is more than or equal to a threshold value C;
then the background-color replacing unit sets a threshold value D equal to approximately a beginning luminance value of the background color peak; and
the background-color replacing unit replaces all luminance values that are more than or equal to the threshold value D with the luminance value of the color that will not be a target for printing.

6. The image processing apparatus according to claim 5, wherein:
the threshold value A is determined based on a minimum value of values acquired when the surface of the original-document cover unit is scanned;
the threshold value B is determined in accordance with an outer circumference of the original document; and
the threshold value C is determined in accordance with a size of the original document.

7. The image processing apparatus according to claim 6, wherein:
the threshold value A is a luminance value of approximately 240;
the threshold value B is approximately 4000 pixels;
the threshold value C is approximately 200000 pixels; and
the threshold value D is a luminance value of approximately 208.

8. The image processing apparatus according to claim 4, wherein
the luminance of the surface of the original document cover unit is higher than the luminance of a background color of a newspaper, and
the background color is the background color of the newspaper.

9. The image processing apparatus according to claim 3, wherein, when the original document cover unit is opened when the original document is scanned:
the background-color-portion specifying unit specifies, in the histogram, the background color peak as a first local maximum portion on a side of higher luminance, and an open peak as a first local maximum portion on a side of lower luminance.

10. The image processing apparatus according to claim 9, wherein
when the background-color-portion specifying unit determines that the number of pixels that indicates a height of the background color peak is more than or equal to a threshold value C, then the background-color replacing unit sets a threshold value D equal to approximately a beginning luminance value of the background color peak; and
the background-color replacing unit replaces all luminance values that are more than or equal to the threshold value D with the luminance value of the color that will not be a target for printing.

11. An image processing apparatus comprising:
an image acquiring unit that acquires an image by optically scanning an original document;
a background-color-portion specifying unit that creates, when an instruction indicating that the original document is a newspaper clipping is acquired from an operator, a histogram indicating the number of pixels with respect to each luminance value of the image acquired by the image acquiring unit, specifies a background color peak that corresponds to a background color of the original document in the created histogram, and specifies, as a background color portion, a portion of the original document that corresponds to a luminance area including the background color peak; and
a background-color replacing unit that replaces the background color portion with a color that will not be a target for printing.

12. The image processing apparatus according to claim 11, wherein when the instruction indicating that the original document is the newspaper clipping is acquired from the operator, the background-color-portion specifying unit specifies, as the background color portion, a portion at which a color predetermined as a background color of a newspaper is represented in the image.

13. The image processing apparatus according to claim 11, further comprising an original document cover unit that covers and presses the original document to be scanned by the image acquiring unit, and that has a surface with higher luminance than a luminance of the background color of the newspaper.

14. The image processing apparatus according to claim 13, wherein, when the original document cover unit is closed when the original document is scanned:
the background-color-portion specifying unit specifies, in the histogram, a platen peak as a peak that corresponds to a luminance value of the surface of the original document cover unit, and the background color peak as a peak that is closer to black than the platen peak.

15. The image processing apparatus according to claim 13, wherein, when the original document cover unit is opened when the original document is scanned:
the background-color-portion specifying unit specifies, in the histogram, the background color peak as a first local maximum portion on a side of higher luminance, and an open peak as a first local maximum portion on a side of lower luminance.

16. An image processing method comprising the steps of:
acquiring an image by optically scanning an original document;
determining whether or not the original document is of standard size;
creating, when the original document is determined not to be of standard size, a histogram indicating the number of pixels with respect to each luminance value of the acquired image;
specifying a background color peak that corresponds to a background color of the original document in the created histogram;
specifying, as a background color portion, a portion of the original document that corresponds to a luminance area including the background color peak; and
replacing the background color portion with a color that will not be a target for printing.

17. The image processing method according to claim 16, further comprising:
determining whether an original document cover unit is opened or closed when the original document is scanned;
if the original document cover unit is closed, specifying in the histogram a platen peak as a peak that corresponds to a luminance value of a surface of the original document cover unit, and the background peak as a peak that is closer to black than the platen peak; and
if the original document cover unit is opened, specifying in the histogram the background color peak as a first local maximum portion on a side of higher luminance, and an open peak as a first local maximum portion on a side of lower luminance.

18. The image processing method according to claim 17, wherein the step of determining whether the original document cover unit is opened or closed comprises determining the existence or absence of the platen peak.

19. The image processing method according to claim 17, wherein the step of determining whether the original document cover unit is opened or closed comprises determining the existence or absence of the open peak.

20. An image processing method comprising the steps of:
acquiring an image by optically scanning an original document;
creating, when an instruction indicating that the original document is a newspaper clipping is acquired from an operator, a histogram indicating the number of pixels with respect to each luminance value of the acquired image;
specifying a background color peak that corresponds to a background color of the original document in the created histogram;
specifying, as a background color portion, a portion of the original document that corresponds to a luminance area including the background color peak; and
replacing the background color portion with a color that will not be a target for printing.
